(19) United States
(12) Patent Application Publication
(10) Pub. No.: US 2021/0192427 A1
(43) Pub. Date: Jun. 24, 2021

(54) MAINTENANCE STAFF MANAGEMENT SYSTEM

(71) Applicant: TOSHIBA TEC KABUSHIKI KAISHA, Tokyo (JP)

(72) Inventor: Kuangsheng Yu, Izunokuni Shizuoka (JP)

(21) Appl. No.: 16/992,149

(22) Filed: Aug. 13, 2020

(30) Foreign Application Priority Data
Dec. 24, 2019 (JP) 2019-233060

(51) Int. Cl. G06Q 10/06

(52) U.S. Cl. CPC G06Q 10/063118; G06Q 10/06398; G06Q 10/06316; G06Q 10/063112

(57) ABSTRACT

According to one embodiment, a maintenance staff management system includes a mobile terminal of a maintenance staff, and a server device configured to determine a maintenance staff to perform a repair work based on information transmitted from the mobile terminal. The mobile terminal includes first measurement means, second measurement means, and transmission means. The first measurement means measures movement time of its own device. The second measurement means measures work time of the repair work based on information received from a repair target device. The transmission means transmits a maintenance staff code capable of identifying the maintenance staff, the movement time, and the work time. The server device include reception means and determination means. The reception means receives the maintenance staff code, the movement time, and the work time. The determination means determines the maintenance staff to perform the repair work based on cumulative time information in which the movement time spent by each of a plurality kinds of repair and the work time are recorded on a per maintenance staff code basis.

### CROSS-REFERENCE TO RELATED APPLICATION

This application is based upon and claims the benefit of priority from Japanese Patent Application No. 2019-233060, filed in Dec. 24, 2019, the entire contents of which are incorporated herein by reference.

### FIELD

Embodiments described herein relate generally to a maintenance staff management system.

### BACKGROUND

In the related art, a maintenance staff of a repair target device goes to a location where the repair target device is installed and performs a repair work. In such repair, a lot of repair works may be assigned to a specific maintenance staff.

It is unequal that the burden is unevenly distributed to a specific maintenance staff. When distributing the repair work, it is required to distribute the repair work so that the repair work can be more efficiently performed. Therefore, a technology that can evenly distribute the repair work to each maintenance staff is required.

### DESCRIPTION OF THE DRAWINGS

FIG. 1 is an explanatory diagram illustrating an example of a maintenance staff management system according to the present embodiment;

FIG. 2 is a block diagram illustrating an example of a hardware configuration of a POS terminal;

FIG. 3 is a block diagram illustrating an example of a hardware configuration of a mobile terminal;

FIG. 4 is a block diagram illustrating an example of a hardware configuration of a management server;

FIG. 5 is a diagram illustrating an example of a data configuration of a cumulative time table;

FIG. 6 is a diagram illustrating an example of a data configuration of a work-specific time table;

FIG. 7 is a block diagram illustrating a characteristic function configuration of each device of the maintenance staff management system;

FIG. 8 is a flowchart for describing an example of a recording process performed by the maintenance staff management system; and

FIG. 9 is a flowchart for describing an example of a determination process performed by the maintenance staff management system.

### DETAILED DESCRIPTION

An aspect to be achieved by the present embodiment is to provide a maintenance staff management system capable of supporting distribution of a repair work.

In general, according to one embodiment, a maintenance staff management system includes a mobile terminal of a maintenance staff, and a server device configured to determine a maintenance staff to perform a repair work based on information transmitted from the mobile terminal. The mobile terminal includes first measurement means, second measurement means, and transmission means. The first measurement means measures movement time of its own device. The second measurement means measures work time of the repair work based on information received from a repair target device. The transmission means transmits a maintenance staff code capable of identifying the maintenance staff, the movement time, and the work time. The server device include reception means and determination means. The reception means receives the maintenance staff code, the movement time, and the work time. The determination means determines the maintenance staff to perform the repair work based on cumulative time information in which the movement time spent by each of a plurality kinds of repair and the work time are recorded on a per maintenance staff code basis. According to another embodiment, a maintenance staff management method involves measuring movement time of the mobile terminal; measuring work time of the repair work based on information received from a repair target device; transmitting a maintenance staff code capable of identifying the maintenance staff, the movement time, and the work time; receiving the maintenance staff code, the movement time, and the work time; and determining the maintenance staff from a plurality of maintenance staff to perform the repair work based on information transmitted from a mobile terminal; and cumulative time information in which the movement time spent by each of a plurality kinds of repair and the work time are recorded on a per maintenance staff code basis.

Hereinafter, with reference to the accompanying drawings, embodiments of a maintenance staff management system are specifically described. The embodiments described below are an embodiment of the maintenance staff management system, and are not intended to limit the configuration or specification thereof.

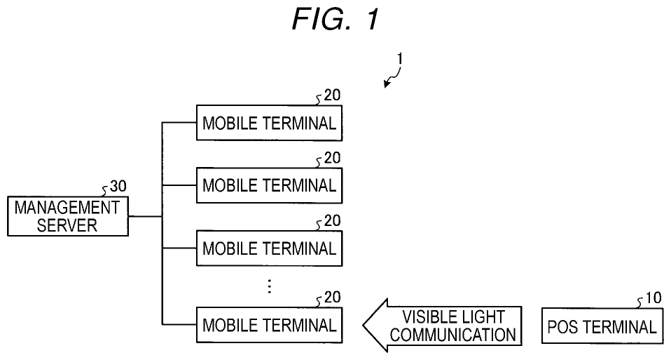

FIG. 1 is an explanatory diagram illustrating an example of a maintenance staff management system 1 according to the present embodiment. The maintenance staff management system 1 is a system configured to manage the determination of a maintenance staff to repair a repair target device. The maintenance staff management system 1 includes a plurality of point of sales (POS) terminal 10, a plurality of mobile terminals 20, and a management server 30. The management server 30 and the plurality of mobile terminals 20 are communicably connected to each other via a network.

The POS terminal 10 is a repair target device according to the present embodiment. In the present embodiment, a case where the repair target device is the POS terminal 10 is described. However, the repair target device is not limited to the POS terminal 10, and may be other devices. The POS terminal 10 is a device to perform a merchandise registration process for registering a merchandise to be sold and a payment process of the merchandise registered in the merchandise registration process. The POS terminal 10 notifies the mobile terminal 20 of the start and the end of the repair work by the visible light communication.

The mobile terminal 20 is a mobile terminal that is carried by each maintenance staff. For example, the mobile terminal 20 is a terminal such as a smartphone or a tablet terminal. The mobile terminal 20 detects a start of movement and arrival at a location where the POS terminal 10 to be repaired is installed based on the position of the mobile terminal 20 which is the own device. The mobile terminal 20 detects the start and end of the repair work based on the information transmitted from the POS terminal 10 to be repaired by the visible light communication.

The management server 30 is a server device that manages the maintenance staff management system 1. The management server 30 determines a maintenance staff to perform a repair work based on the information transmitted from the mobile terminal 20. Specifically, the management server 30 determines a maintenance staff to repair a device based on the work time of a repair work transmitted from the mobile terminal 20 or the movement time of the maintenance staff. The management server 30 is not limited to one server device, and may be configured with a plurality of server devices.

Subsequently, hardware configurations of various devices included in the maintenance staff management system 1 are described.

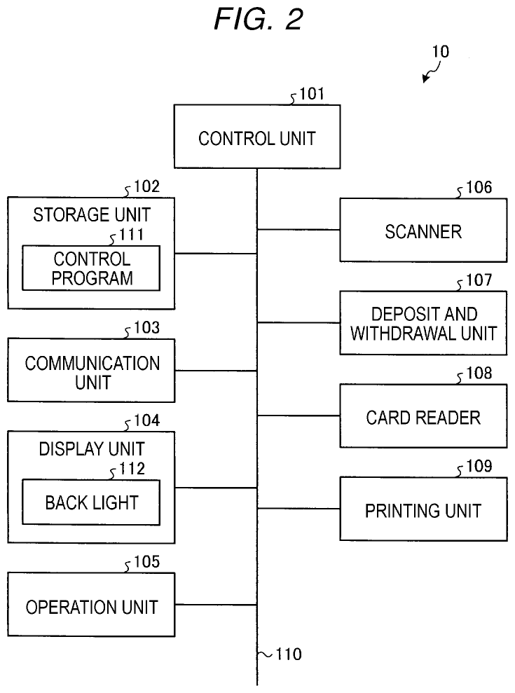

FIG. 2 is a block diagram illustrating an example of a hardware configuration of the POS terminal 10. The POS terminal 10 includes a control unit 101, a storage unit 102, a communication unit 103, a display unit 104, an operation unit 105, a scanner 106, a deposit and withdrawal unit 107, a card reader 108, and a printing unit 109. These units are connected to each other via a system bus 110 such as a data bus or an address bus.

The control unit 101 is a computer that controls the entire operation of the POS terminal 10 and realizes various functions of the POS terminal 10. The control unit 101 includes a central processing unit (CPU), a read only memory (ROM), and a random access memory (RAM). The CPU integrally controls the operation of the POS terminal 10. The ROM is a storage medium that stores various programs or data. The RAM is a storage medium that temporarily stores various programs or various kinds of data. Also, the CPU executes a program stored in the ROM, the storage unit 102, or the like while using the RAM as the work area.

The storage unit 102 is a storage device such as a hard disk drive (HDD) or a solid state drive (SSD). The storage unit 102 stores a control program 111. The control program 111 is a program for implementing functions of an operating system or the POS terminal 10. The control program 111 includes a program for implementing a characteristic function according to the present embodiment.

The communication unit 103 is an interface for a communication with other devices via the network. For example, the communication unit 103 communicates with a device connected to a network in a store where the POS terminal 10 is installed.

The display unit 104 is, for example, a display device such as a liquid crystal display. The display unit 104 includes a back light 112 that illuminates from the back surface of the liquid crystal. The back light 112 is a light emitting device such as a light emitting diode (LED). The back light 112 transmits various kinds of information by the visible light communication. Here, the visible light communication is a communication that transmits information by emitting visible light including information. In the present embodiment, the case where the back light 112 of the display unit 104 emits visible light including various kinds of information is described as an example. However, the POS terminal 10 may emit visible light including various kinds of information from an LED provided outside of the display unit 104 or may emit visible light including various kinds of information from a light emitting device other than the POS terminal 10.

The operation unit 105 is an input device such as a touch pad that receives various operations by detecting a touched position on a screen of the display unit 104. The operation unit 105 may be a hardware button or the like.

The scanner 106 acquires a merchandise code capable of identifying a merchandise by reading a barcode attached to a merchandise.

The deposit and withdrawal unit 107 is an automatic change machine that deposits and withdraws money in a process such as a payment process. The deposit and withdrawal unit 107 receives money such as coins or bills deposited from a deposit port in a reception unit. The deposit and withdrawal unit 107 withdraws money such as coins or bills as a change, from a reception unit to a withdrawal port.

The card reader 108 reads a card such as a credit card.

The printing unit 109 is a printer for printing various kinds of information.

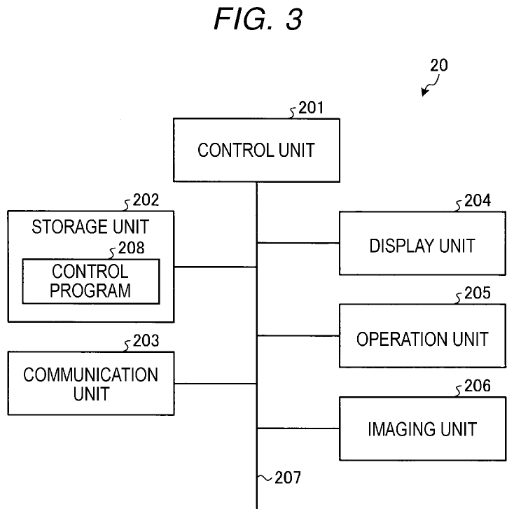

FIG. 3 is a block diagram illustrating an example of a hardware configuration of the mobile terminal 20. The mobile terminal 20 includes a control unit 201, a storage unit 202, a communication unit 203, a display unit 204, an operation unit 205, and an imaging unit 206. These units are connected to each other via a system bus 207 such as a data bus or an address bus.

The control unit 201 is a computer that controls the entire operation of the mobile terminal 20 and realizes various functions of the mobile terminal 20. The control unit 201 includes a CPU, a ROM, and a RAM. The CPU integrally controls the operation of the mobile terminal 20. The ROM is a storage medium that records various programs or data. The RAM is a storage medium that temporarily records various programs or various kinds of data. Also, the CPU executes a program stored in the ROM, the storage unit 202, or the like while using the RAM as the work area.

The storage unit 202 is a storage device such as flash memory. The storage unit 202 records a control program 208. The control program 208 is a program for implementing functions of an operating system or the mobile terminal 20. The control program 208 includes a program for implementing a characteristic function according to the present embodiment.

The communication unit 203 is an interface for a communication with other devices via the network. For example, the communication unit 203 is an interface for a communication with the management server 30.

The display unit 204 is, for example, a display device such as a liquid crystal display. The operation unit 205 is an input device such as a touch pad that receives various operations by detecting a touched position on a screen of the display unit 204. The operation unit 205 may be a hardware button or the like.

The imaging unit 206 is a camera including an imaging element such as a complementary metal-oxide semiconductor (CMOS) or a charge coupled device (CCD). The imaging unit 206 images the display unit 104 of the POS terminal 10, to receive the information transmitted by the POS terminal 10 via the visible light communication.

Here, the maintenance staff is required to obtain permission of the store in order to connect the mobile terminal 20 to the network of the store where the POS terminal 10 is installed. However, when the information is received from the POS terminal 10 via the visible light communication, the mobile terminal 20 is not connected to the network of the store. Accordingly, the maintenance staff is not required to obtain the permission of the store in the visible light communication.

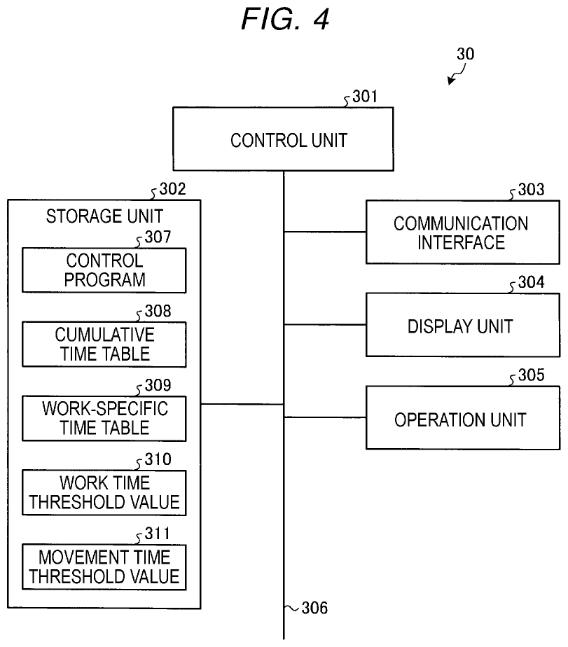

FIG. 4 is a block diagram illustrating an example of a hardware configuration of the management server 30. The management server 30 includes a control unit 301, a storage unit 302, a communication interface 303, a display unit 304, and an operation unit 305. These units are connected to each other via a system bus 306 such as a data bus or an address bus.

The control unit 301 is a computer that controls the entire operation of the management server 30 and realizes various functions of the management server 30. The control unit 301 includes a CPU, a ROM, and a RAM. The CPU integrally controls the operation of the management server 30. The ROM is a storage medium that records various programs or data. The RAM is a storage medium that temporarily records various programs or various kinds of data. Also, the CPU executes a program stored in the ROM, the storage unit 302, or the like while using the RAM as the work area.

The storage unit 302 is a storage device such as a HDD or a SSD. The storage unit 302 stores a control program 307, a cumulative time table 308, a work-specific time table 309, a work time threshold value 310, and a movement time threshold value 311. The cumulative time table 308, the work-specific time table 309, the work time threshold value 310, and the movement time threshold value 311 are not limited to the management server 30, and may be stored in other devices. The cumulative time table 308, the work-specific time table 309, the work time threshold value 310, and the movement time threshold value 311 are not limited to one device, and may be stored in a plurality of devices in a dispersed manner. The control program 307 is a program for implementing functions of an operating system or the management server 30. The control program 307 includes a program for implementing a characteristic function according to the present embodiment.

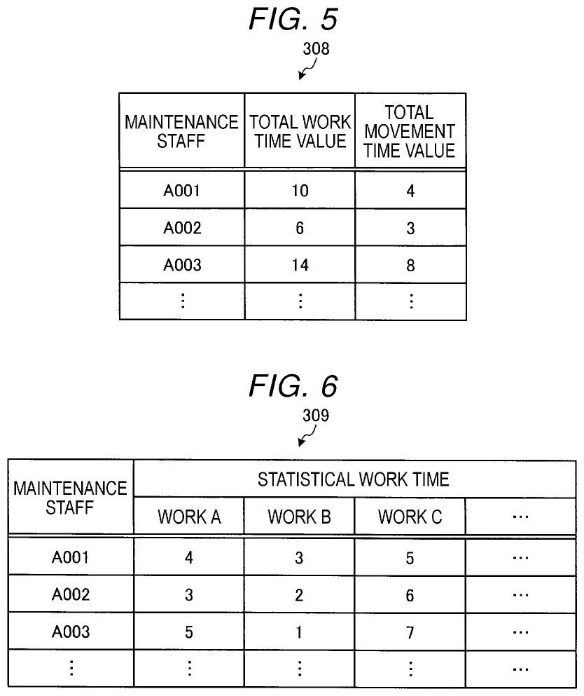

The cumulative time table 308 is cumulative time information having a total value of the work time and a total value of movement time spent for the repair by each maintenance staff. Here, FIG. 5 is a diagram illustrating an example of a data configuration of the cumulative time table 308. In the cumulative time table 308, the maintenance staff code, the total work time value, and the total movement time value are correlated with each other. The maintenance staff code is identification information capable of identifying a maintenance staff. The total work time value is a total value of the time spent for the repair work by the maintenance staff. The total movement time value is a total value of time spent for the movement of the maintenance staff. The total work time value and the total movement time value may be total values of one month, may be total values of one year, or may be total values of other periods.

The work-specific time table 309 is an information table presenting time spent for each repair work by each maintenance staff. Here, FIG. 6 is a diagram illustrating an example of a data configuration of the work-specific time table 309. In the work-specific time table 309, the maintenance staff code and the statistical work time on a per repair work type basis are correlated with each other. The maintenance staff code is identification information capable of identifying a maintenance staff. The statistical work time is a value calculated based on an actual value of the time spent for each repair work of the maintenance staff. For example, the statistical work time may be an average value, may be a median value, or may be a value calculated by other methods. In this manner, the time spent for each repair work is recorded on a per maintenance staff basis, so that the information can be used for identifying a repair work at which a maintenance staff is skilled.

The work time threshold value 310 is a threshold value of the work time for assigning the repair work to the maintenance staff. The repair work cannot be assigned to a maintenance staff whose total work time value is the work time threshold value 310 or more. Meanwhile, the repair work can be assigned to a maintenance staff whose total work time value is less than the work time threshold value 310. The work time threshold value 310 may be a value set in advance, may be a calculated value such as an average value or a median value of the total work time value of each maintenance staff, or may be a value acquired by other methods.

The movement time threshold value 311 is a threshold value of the movement time for assigning a repair work to a maintenance staff. The repair work cannot be not assigned to a maintenance staff whose total movement time value is the movement time threshold value 311 or more. Meanwhile, the repair work can be assigned to a maintenance staff whose total movement time value is less than the movement time threshold value 311. The movement time threshold value 311 may be a value set in advance, may be a calculated value such as an average value or a median value of the total movement time value of each maintenance staff, or may be a value acquired by other methods.

The communication interface 303 is an interface for a communication with other devices via the network. For example, the communication interface 303 is an interface for a communication with the mobile terminal 20.

The display unit 304 is, for example, a display device such as a liquid crystal display. The operation unit 305 is an input device such as a keyboard or a mouse.

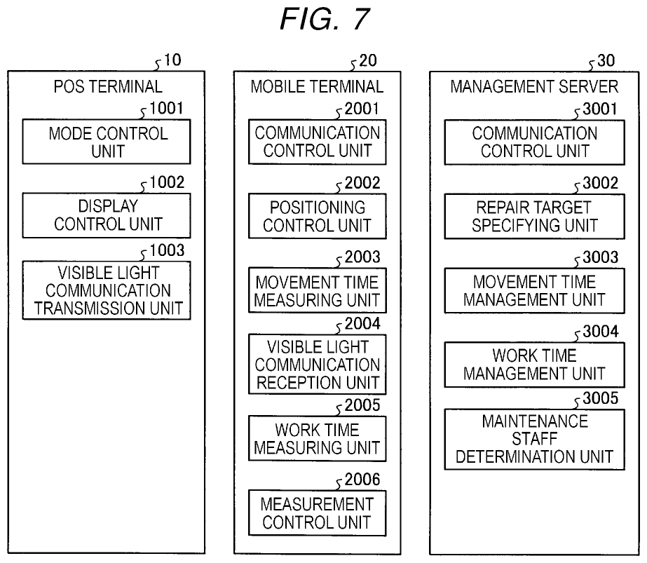

Subsequently, a characteristic function of each device of the maintenance staff management system 1 is described. Here, FIG. 7 is a block diagram illustrating a characteristic function configuration of each device of the maintenance staff management system 1.

The control unit 101 of the POS terminal 10 loads the control program 111 stored in the storage unit 102 into a RAM and is operated according to the control program 111 to generate each functional unit in the RAM. Specifically, the control unit 101 of the POS terminal 10 includes a mode control unit 1001, a display control unit 1002, and a visible light communication transmission unit 1003 as the functional units.

The mode control unit 1001 controls the mode change of the POS terminal 10. Examples of the mode of the POS terminal 10 include a general mode and a repair mode. The general mode is a mode for performing a merchandise registration process for registering a merchandise to be sold and a payment process of the merchandise registered in the merchandise registration process. The repair mode is a mode set when a maintenance staff repairs a device. The mode control unit 1001 changes the general mode to the repair mode when a maintenance staff code, a password corresponding to the maintenance staff code, and the like are input. Here, the maintenance staff code and the password may be input by causing the operation unit 105 to receive an input or by causing the card reader 108 to read a card or may be input by other methods. The mode control unit 1001 changes the repair mode to the general mode when an operation for ending repair is input in the repair mode.

The display control unit 1002 controls the display unit 104 and causes various screens to be displayed. For example, in the repair mode, the display control unit 1002 causes screens for performing various kinds of repair to be displayed.

The visible light communication transmission unit 1003 controls the back light 112 of the display unit 104 and transmits information by visible light communication. That is, the visible light communication transmission unit 1003 transmits the information by causing the back light 112 of the display unit 104 to blink at a high speed. For example, in the repair mode, the visible light communication transmission unit 1003 makes a notification that the repair is performed. Also, the mobile terminal 20 measures work time spent for the repair work based on the information transmitted by the visible light communication. Here, the visible light communication transmission unit 1003 may transmit any kind of information in order to cause the mobile terminal 20 to measure the work time. For example, when the visible light communication transmission unit 1003 transmits information indicating that the mode is the repair mode, the mobile terminal 20 can measure the work time by interpreting the first notification as a start of a work and the second notification as an end of a work. Otherwise, the visible light communication transmission unit 1003 may transmit information specifying the start of a work and the end of a work. Also in this case, the mobile terminal 20 can measure work time. Otherwise, the visible light communication transmission unit 1003 may transmit the work time when the repair ends. Also in this case, the mobile terminal 20 can measure the work time.

The control unit 201 of the mobile terminal 20 loads the control program 208 stored in the storage unit 202 into a RAM and is operated according to the control program 208 to generate each functional unit in the RAM. Specifically, the control unit 201 of the mobile terminal 20 includes a communication control unit 2001, a positioning control unit 2002, a movement time measuring unit 2003, a visible light communication reception unit 2004, a work time measuring unit 2005, and a measurement control unit 2006 as the functional units.

The communication control unit 2001 controls the communication unit 203 and communicates with the management server 30. For example, the communication control unit 2001 transmits the movement time to the store where the POS terminal 10 which is a repair target device is installed and the work time spent for the repair. For example, the communication control unit 2001 transmits the maintenance staff code indicating the maintenance staff who carries the mobile terminal 20 and the movement time to the store where the POS terminal 10 which is the repair target device is installed in a correlating manner. The communication control unit 2001 transmits the maintenance staff code indicating a maintenance staff who carries the mobile terminal 20 and the work time spent for the repair in a correlating manner.

The positioning control unit 2002 positions a position of its own device which is the mobile terminal 20. For example, the positioning control unit 2002 positions the position of its own device by a global positioning satellite (GPS). That is, the positioning control unit 2002 acquires position information indicating the position of its own device, to position the position of its own device. The positioning control unit 2002 is not limited to the GPS, and may position the position of its own device by other methods. For example, the positioning control unit 2002 may position the position of its own device based on the position of a base station with which the mobile terminal 20 communicates, may position the position of its own device based on a position of an access point of a wireless local area network (LAN) with which the mobile terminal 20 communicates, or may position the position of its own device by other methods.

The movement time measuring unit 2003 measures the movement time of its own device. Specifically, the movement time measuring unit 2003 measures the movement time based on the position of its own device. Specifically, when the maintenance staff moves from a waiting place where the maintenance staff waits by a predetermined distance or more, the movement time measuring unit 2003 determines that the movement from the POS terminal 10 which is the repair target device to the store where the repair target device is installed is started. When the movement time measuring unit 2003 determines that its own device enters the store where the POS terminal 10 is installed, the movement time measuring unit 2003 determines that the movement is ended. The movement time measuring unit 2003 measures the time from the start of movement to the end of movement. Accordingly, the movement time measuring unit 2003 measures the movement time of its own device. The movement time measuring unit 2003 is not limited to measure the movement time when the maintenance staff goes from the waiting location where the maintenance staff waits to the store, but may measure the movement time when the maintenance staff returns from the store to the waiting location.

The visible light communication reception unit 2004 controls the imaging unit 206 that receives visible light emitted from the POS terminal 10 and receives the information transmitted by the visible light communication.

The work time measuring unit 2005 measures the work time of the repair work based on the information received from the POS terminal 10 which is the repair target device. Specifically, the work time measuring unit 2005 measures the work time based on the information transmitted from the POS terminal 10 which is the repair target device by the visible light communication. Specifically, when the visible light communication reception unit 2004 receives the first information, the work time measuring unit 2005 determines that the repair work is started. When the visible light communication reception unit 2004 receives the second information, the work time measuring unit 2005 determines that the repair work is ended. Also, the work time measuring unit 2005 measures the time from the start of the work to the end of the work. Accordingly, the work time measuring unit 2005 measures the movement time of its own device. When the visible light communication reception unit 2004 receives the information for specifying the start of the work and the end of the work, the work time measuring unit 2005 may determine the start of the work and the end of the work based on the received information.

The measurement control unit 2006 controls the transmission of the movement time and the work time to the management server 30. Specifically, when the movement time measuring unit 2003 measures the movement time, the measurement control unit 2006 transmits the maintenance staff code and the movement time to the communication control unit 2001 in a correlating manner. When the work time measuring unit 2005 measures the work time, the measurement control unit 2006 transmits the maintenance staff code and the work time to the communication control unit 2001 in a correlating manner. The present embodiment is not limited to a case where the movement time and the work time are measured, and the measurement control unit 2006 may transmit the information to the communication control unit 2001 when an operation for transmitting the movement time and the work time is received, or may transmit the information to the communication control unit 2001 based on other reasons.

The control unit 301 of the management server 30 loads the control program 307 stored in the storage unit 302 into the RAM, and is operated according to the control program 307 to generate each functional unit in the RAM. Specifically, the control unit 301 of the management server 30 includes a communication control unit 3001, a repair target specifying unit 3002, a movement time management unit 3003, a work time management unit 3004, and a maintenance staff determination unit 3005 as the functional units.

The communication control unit 3001 controls the communication interface 303 and communicates with the mobile terminal 20. For example, the communication control unit 3001 receives the movement time correlating with the maintenance staff code from each of the mobile terminals 20. The communication control unit 3001 receives the work time correlating with the maintenance staff code from each of the mobile terminals 20.

The repair target specifying unit 3002 specifies the POS terminal 10 that is the repair target device to be subjected to the repair work and a type of the repair work performed on the repair target device. For example, the repair target specifying unit 3002 specifies the repair target device and the type of the repair work based on the operation received by the operation unit 305. Otherwise, the repair target specifying unit 3002 specifies the repair target device and the type of the repair work based on the information received by the communication control unit 3001.

The movement time management unit 3003 manages the movement time on a per maintenance staff basis. Specifically, when the communication control unit 3001 receives the movement time correlating with the maintenance staff code, the movement time management unit 3003 adds the movement time to the total movement time value correlating with the maintenance staff code which is the same as the received maintenance staff code in the cumulative time table 308.

The work time management unit 3004 manages the work time on a per maintenance staff basis. Specifically, when the communication control unit 3001 receives the work time correlating with the maintenance staff code, the work time management unit 3004 adds the work time to the total work time value correlating with the maintenance staff code which is the same as the received maintenance staff code in the cumulative time table 308.

The work time management unit 3004 updates the work-specific time table 309. Specifically, the work time management unit 3004 specifies the type of the repair work assigned to the maintenance staff of the received maintenance staff code. Here, the specifying method is not limited. For example, when the type of the repair work assigned to the maintenance staff is stored in the management server 30, the type of the repair work may be extracted from the management server 30, the type of the repair work assigned to the maintenance staff may be transmitted to the mobile terminal 20, or the type of the repair work may be specified by other methods. The work time management unit 3004 calculates the statistical work time based on the work time of the maintenance staff of the received maintenance staff code up to date and the received work time with respect to the specified type of the repair work. The work time management unit 3004 updates the work-specific time table 309 by registering the calculated value in the work-specific time table 309.

The maintenance staff determination unit 3005 determines the maintenance staff to perform the repair work based on the cumulative time table 308 in which the movement time and the work time spent in each of the plurality of repair works on a per maintenance staff code basis are recorded. Specifically, the maintenance staff determination unit 3005 determines the maintenance staff whose movement time and work time are less than the threshold values as the maintenance staff to perform the repair work. That is, the maintenance staff determination unit 3005 determines the maintenance staff whose movement time is less than the movement time threshold value 311 and whose work time is less than the work time threshold value 310 as the maintenance staff to perform the repair work.

The maintenance staff determination unit 3005 determines the maintenance staff to perform a repair work based on the statistical value of the work time of each maintenance staff recorded on a per repair work type basis. That is, the maintenance staff determination unit 3005 determines the maintenance staff skilled at the repair work to be performed, that is, the maintenance staff to perform the repair work. Specifically, the maintenance staff determination unit 3005 selects the maintenance staff whose statistical work time of the repair work to be performed is the least, among the plurality of maintenance staffs based on the work-specific time table 309. When the movement time of the selected maintenance staff is less than the movement time threshold value 311 and the work time is less than the work time threshold value 310, the maintenance staff determination unit 3005 determines the selected maintenance staff as the maintenance staff to perform the repair work. When the movement time of the selected maintenance staff is the movement time threshold value 311 or more, or the work time is the work time threshold value 310 or more, a maintenance staff whose statistical work time of the repair work to be performed is the second least next to the selected maintenance staff is selected. When the movement time of the selected maintenance staff is less than the movement time threshold value 311, and the work time is less than the work time threshold value 310, the maintenance staff determination unit 3005 determines the selected maintenance staff as the maintenance staff to perform the repair work. By repeating this, the maintenance staff determination unit 3005 can select the maintenance staff skilled at the repair work to be performed.

Subsequently, an operation of the maintenance staff management system 1 is described.

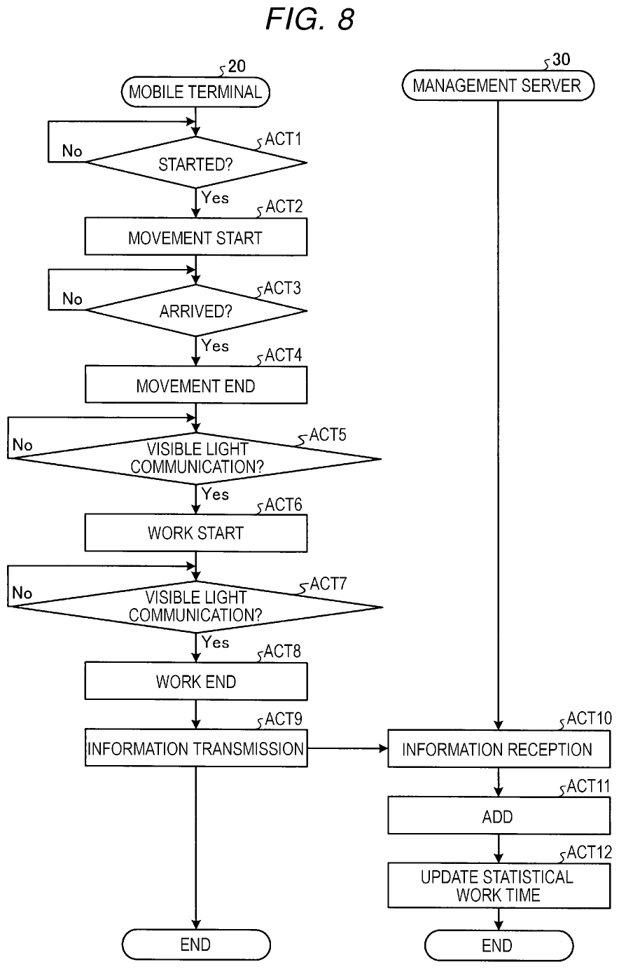

FIG. 8 is a flowchart for describing an example of a recording process performed by the maintenance staff management system 1 according to the present embodiment. The recording process is a process for recording the movement time and the work time of the maintenance staff.

The movement time measuring unit 2003 of the mobile terminal 20 determines whether the maintenance staff starts moving based on a positioning result of the positioning control unit 2002 (ACT 1). When a positioning result indicates that the mobile terminal 20 is present at a position closer than a predetermined distance from the waiting place (ACT 1; No), the movement time measuring unit 2003 determines that the movement is not started.

When a positioning result indicates that the mobile terminal 20 is present at a position in a predetermined distance or farther from the waiting place (ACT 1; Yes), the movement time measuring unit 2003 determines that the movement is started (ACT 2). That is, the movement time measuring unit 2003 starts the measurement of the movement time.

The movement time measuring unit 2003 determines whether the maintenance staff ends the movement based on the positioning result of the positioning control unit 2002 (ACT 3). When a positioning result indicates that the mobile terminal 20 is present at a position in a predetermined distance or farther from the store where the POS terminal 10 which is the repair target device is installed (ACT 3; No), the movement time measuring unit 2003 determines that the movement is not ended. That is, the movement time measuring unit 2003 continues to measure the movement time.

When the positioning result indicates that the mobile terminal 20 is present at a position closer than a predetermined distance from the store where the POS terminal 10 which is the repair target device is installed (ACT 3; Yes), the movement time measuring unit 2003 determines that the movement ends (ACT 4). That is, the movement time measuring unit 2003 ends the measurement of the movement time.

The visible light communication reception unit 2004 determines whether visible light communication indicating the repair start is received (ACT 5). The visible light communication indicating the repair start is not received (ACT 5; No), the visible light communication reception unit 2004 stands by.

When the visible light communication indicating the repair start is received (ACT 5; Yes), the work time measuring unit 2005 determines that the work is started (ACT 6). That is, the work time measuring unit 2005 starts the measurement of the work time of the repair work.

The visible light communication reception unit 2004 determines whether the visible light communication indicating the repair end is received (ACT 7). When the visible light communication indicating the repair end is not received (ACT 7; No), the visible light communication reception unit 2004 stands by. That is, the work time measuring unit 2005 continues to measure the work time of the repair work.

When the visible light communication indicating the repair end is received (ACT 7; Yes), the work time measuring unit 2005 determines that the work is ended (ACT 8). That is, the work time measuring unit 2005 ends the measurement of the work time of the repair work.

The communication control unit 2001 transmits the information (ACT 9). That is, the communication control unit 2001 transmits the maintenance staff code, the movement time, and the work time to the management server 30 in a correlating manner.

The communication control unit 2001 of the management server 30 receives the information (ACT 10). That is, the communication control unit 3001 receives the information in which the maintenance staff code, the movement time, and the work time are correlated with each other.

The movement time management unit 3003 adds the received movement time to the total movement time value correlating with the maintenance staff code which is the same as the received maintenance staff code in the cumulative time table 308 (ACT 11).

The work time management unit 3004 updates the statistical work time of the work-specific time table 309 (ACT 12). That is, the work time management unit 3004 calculates the statistical work time based on the work time of the maintenance staff of the received maintenance staff code up to date and the received work time. Also, the work time management unit 3004 registers the calculated value in the work-specific time table 309, to update the statistical work time of the work-specific time table 309.

As above, the maintenance staff management system 1 ends the recording process.

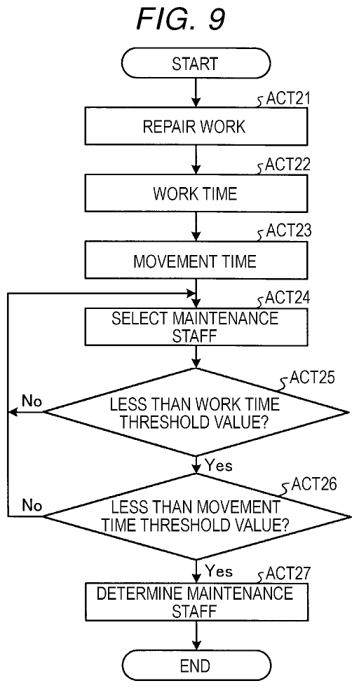

FIG. 9 is a flowchart for describing an example of a determination process performed by the maintenance staff management system 1 according to the present embodiment. The determination process is a process for determining a maintenance staff who performs the repair work.

The repair target specifying unit 3002 specifies the POS terminal 10 which is the repair target device that performs a repair work and the type of the repair work to be performed on the repair target device (ACT 21).

The movement time management unit 3003 acquires the total movement time value which is the total value of the movement time of each maintenance staff from the cumulative time table 308 (ACT 22).

The work time management unit 3004 acquires the total work time value which is the total value of the work time of each maintenance staff from the cumulative time table 308 (ACT 23).

The maintenance staff determination unit 3005 selects the maintenance staff the most skilled at the repair work to be performed among a plurality of maintenance staffs based on the work-specific time table 309 (ACT 24).

The maintenance staff determination unit 3005 determines whether the acquired total work time value is less than the work time threshold value 310 (ACT 25).

When the acquired total work time value is the work time threshold value 310 or more (ACT 25; No), the process transitions to ACT 24, and the maintenance staff determination unit 3005 selects a maintenance staff most skilled at the repair work to be performed among maintenance staffs who are not selected.

When the acquired total work time value is less than the work time threshold value 310 (ACT 25; Yes), the maintenance staff determination unit 3005 determines whether the acquired total movement time value is less than the movement time threshold value 311 (ACT 26).

When the acquired total movement time value is the movement time threshold value 311 or more (ACT 26; No), the process transitions to ACT 24, and the maintenance staff determination unit 3005 selects a maintenance staff most skilled at the repair work to be performed among maintenance staffs who are not selected.

When the acquired total movement time value is less than the movement time threshold value 311 (ACT 26; Yes), the maintenance staff determination unit 3005 determines the selected maintenance staff as a maintenance staff to perform the repair work (ACT 27).

As a result, the maintenance staff management system 1 ends the determination process.

As above, in the maintenance staff management system 1 according to the present embodiment, the mobile terminal 20 measures the movement time of the maintenance staff. The mobile terminal 20 measures the work time based on the information received from the repair target device, and the mobile terminal 20 transmits the movement time and the work time to the management server 30. The management server 30 determines the maintenance staff to perform the repair work based on the cumulative time information in which the received movement time and work time are recorded. Therefore, the maintenance staff management system 1 can support distribution of the repair work.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the above embodiment, it is described that the imaging unit 206 of the mobile terminal 20 receives the visible light communication. However, the visible light communication may be received by other devices. Also, the other devices that receive the visible light communication may transmit a received content to the mobile terminal 20. Specifically, a surveillance camera may receive the visible light communication. The device connected to the surveillance camera may transmit the received content to the mobile terminal 20.

The program executed by each device of the above-described embodiments and modifications is provided by being installed in advance in a storage medium (ROM or storage unit) included in each device, but the embodiment is not limited to this. For example, the program may be configured to be recorded on a computer-readable recording medium such as a CD-ROM, a flexible disk (FD), a CD-R, a digital versatile disk (DVD) as a file provided in an installable or executable format, and provided. Further, the storage medium is not limited to a medium independent from the computer or the embedded system, but also includes a storage medium in which a program transmitted by LAN or the Internet is downloaded and stored or temporarily stored.

In addition, the program executed by each device of the above embodiment and a modification may be configured to be stored on a computer connected to a network such as the Internet and provided by downloading the program via the network or may be configured to be provided or distributed via a network such as the Internet.

What is claimed is:

1. A maintenance staff management system, comprising:
a mobile terminal of a maintenance staff; and
a server device configured to determine a maintenance staff to perform a repair work based on information transmitted from the mobile terminal,
wherein the mobile terminal comprises:
a first measurement component for measuring movement time of the mobile terminal,
a second measurement component for measuring work time of the repair work based on information received from a repair target device, and
a transmission component for transmitting a maintenance staff code capable of identifying the maintenance staff, the movement time, and the work time, and
the server device comprises:
a reception component for receiving the maintenance staff code, the movement time, and the work time, and
a determination component for determining the maintenance staff from a plurality of maintenance staff to perform the repair work based on cumulative time information in which the movement time spent by each of a plurality kinds of repair and the work time are recorded on a per maintenance staff code basis.

2. The system according to claim 1,
wherein the determination component determines a maintenance staff from the plurality of maintenance staff whose the movement time and the work time are less than threshold values as the maintenance staff to perform the repair work.

3. The system according to claim 1,
wherein the determination component determines the maintenance staff from the plurality of maintenance staff to perform the repair work based on a statistical value of the work time of each maintenance staff from the plurality of maintenance staff recorded on a per repair work type basis.

4. The system according to claim 1,
wherein the second measurement component measures the work time based on information transmitted from the repair target device by visible light communication.

5. The system according to claim 1,
wherein the first measurement component measures the movement time based on a position of the mobile terminal.

6. The system according to claim 1,
wherein the mobile terminal is a smartphone.

7. The system according to claim 1,
wherein the repair target device is a POS terminal.

8. A maintenance staff management method, comprising:
measuring movement time of the mobile terminal;
measuring work time of the repair work based on information received from a repair target device;
transmitting a maintenance staff code capable of identifying the maintenance staff, the movement time, and the work time;
receiving the maintenance staff code, the movement time, and the work time; and
determining the maintenance staff from a plurality of maintenance staff to perform the repair work based on
information transmitted from a mobile terminal; and
cumulative time information in which the movement time spent by each of a plurality of kinds of repair and the work time are recorded on a per maintenance staff code basis.

9. The method according to claim 8, further comprising:
determining a maintenance staff from the plurality of maintenance staff whose the movement time and the work time are less than threshold values as the maintenance staff to perform the repair work.

10. The method according to claim 8, further comprising:
determining the maintenance staff from the plurality of maintenance staff to perform the repair work based on a statistical value of the work time of each maintenance staff from the plurality of maintenance staff recorded on a per repair work type basis.

11. The method according to claim 8, further comprising:
measuring the work time based on information transmitted from the repair target device by visible light communication.

12. The method according to claim 8, further comprising:
measuring the movement time based on a position of the mobile terminal.

13. A maintenance staff management device, comprising:
a server device configured to determine a maintenance staff from a plurality of maintenance staff to perform a repair work based on information transmitted from a mobile terminal of the maintenance staff;
the server device comprises:
a reception component for receiving a maintenance staff code capable of identifying the maintenance staff, a movement time, and a work time; and
a determination component for determining the maintenance staff to perform the repair work based on cumulative time information in which the movement time spent by each of a plurality kinds of repair and the work time are recorded on a per maintenance staff code basis.

14. The device according to claim 13,
wherein the determination component determines a maintenance staff from the plurality of maintenance staff whose the movement time and the work time are less than threshold values as the maintenance staff to perform the repair work.

15. The device according to claim 13,
wherein the determination component determines the maintenance staff from the plurality of maintenance staff to perform the repair work based on a statistical value of the work time of each maintenance staff from the plurality of maintenance staff recorded on a per repair work type basis.

16. The device according to claim 13,
wherein the work time is based on information transmitted from the repair target device by visible light communication.

17. The device according to claim 13,
wherein the movement time is based on a position of the mobile terminal.

18. The device according to claim 13,
wherein the mobile terminal is a smartphone.

19. The device according to claim 13,
wherein the repair target device is a POS terminal.
